(19) United States
(12) Patent Application Publication
(10) Pub. No.: US 2024/0105999 A1
(43) Pub. Date: Mar. 28, 2024

(54) ORGANIC CARBONATE-BASED HIGH FLASH POINT ELECTROLYTE

(71) Applicant: KOREA INSTITUTE OF SCIENCE AND TECHNOLOGY, Seoul (KR)

(72) Inventors: Minah Lee, Seoul (KR); A Re Jeon, Seoul (KR); Jina Lee, Seoul (KR); Jihyun Hong, Seoul (KR)

(21) Appl. No.: 18/194,274

(22) Filed: Mar. 31, 2023

(30) Foreign Application Priority Data
Sep. 7, 2022 (KR) 10-2022- 0113379

(51) Int. Cl. H01M 10/0569; H01M 10/0525

(52) U.S. Cl. CPC H01M 10/0569; H01M 10/0525; H01M 2300/0037

(57) ABSTRACT

Provided are an electrolyte which includes a linear organic carbonate compound having a specific substituent, an electrolyte additive, and a lithium salt, has a flash point of 70° C. or higher, and shows an ionic conductivity of 0.05 mS/cm or higher at room temperature in a polyolefin based commercial separator condition, and a lithium secondary battery including the same.

### CROSS-REFERENCE TO RELATED APPLICATION

This application claims the benefit of Korean Patent Application No. 10-2022-0113379 filed on Sep. 7, 2022, in the Korean Intellectual Property Office, the entire disclosure of which is incorporated herein by reference for all purposes.

### BACKGROUND

### 1. Field of the Invention

One or more example embodiments relate to an organic carbonate-based high flash point electrolyte and a lithium secondary battery including the same.

### 2. Description of the Related Art

A linear organic carbonate solution which is a key component of a commercial electrolyte poses a great threat to explosion accidents of lithium metal batteries and lithium ion batteries due to a low flash point.

Conventional technologies have introduced techniques of adding an excessive amount of phosphorous or halogen-based flame retardants which suppress the chain reaction of active radicals to the electrolyte or utilizing a high concentration of salt to eliminate the flammability of the electrolyte in the battery. However, these techniques not only had the low economic feasibility, but also had limitations in maintaining the performance of the existing lithium ion batteries, which made it difficult to be commercialized. When existing flame retardants are used as additives for the electrolytes, the flame retardants cause side reactions with a negative electrode, which is a commercial negative electrode material, making it difficult to apply directly to commercial batteries. Further, in the case of techniques which utilize a high concentration of a salt, 4 to 10 times or more lithium salts than before are used to increase the manufacturing cost and high viscosity of electrolyte causes the poor wettability during the cell manufacturing so that there is a problem in effective performance.

Specifically, linear carbonate-based electrolyte materials which do not cause irreversible electrochemical reactions with commercial positive electrode and negative electrode materials, have high ionic conductivity to enable high power and stable battery operation, and show flame retardant properties which prevent fire have not been reported in detail. According to the existing studies to secure the flame retardancy of carbonate-based solvents, an excessive amount of cyclic carbonate which had a high viscosity and a poor low temperature conductivity was used so that the battery operation was not smooth, or a solvent substituted with an excessive amount of fluorine atoms was applied through a complicated synthesis method to increase the cost and was harmful to the environment and human body due to toxicity when ignited.

Therefore, the inventor of the present disclosure has completed the present disclosure by finding that the possibility of the fire and thermal runaway of the battery could be reduced and the high ionic conductivity could be achieved at the same time, by increasing the flash point of the electrolyte and reducing the self-extinguishing time through controlling a molecular structure of a high flash point organic carbonate solution which was easy to apply to the commercial electrolyte and the battery manufacturing infrastructure.

### RELATED ART DOCUMENT

### Patent Document

Japanese Patent Application Laid-Open Publication No. 2002-83629 (Mar. 22, 2002)

### SUMMARY

Example embodiments provide an electrolyte which includes a linear organic carbonate compound having a specific substituent and an electrolyte additive, has a flash point of 70° C. or higher, and shows an ionic conductivity of 0.05 mS/cm or higher at room temperature in a separator condition of polypropylene (PP) or a combination of polypropylene and polyethylene (PE), and a lithium ion battery including the same.

However, technical problems to be solved by the present disclosure are not limited to the above-mentioned technical problems, and other technical problems, which are not mentioned above, can be clearly understood by those skilled in the art from the following descriptions.

According to an aspect of the present disclosure, there is provided an electrolyte including a linear organic carbonate compound represented by Chemical Formula 1, an electrolyte additive, and a lithium salt.

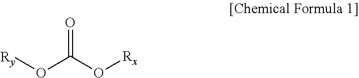

(In Chemical Formula 1, Rₓ and R_{y} each includes at least one selected from the group consisting of an alkoxyalkyl group represented by the following Chemical Formula 2, an alkyl sulfanyl group represented by the following Chemical Formula 3, an alkyl amino group represented by the following Chemical Formula 4, and an alkyl group,

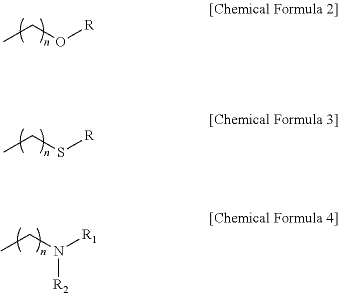

In Chemical Formulae 1 to 4, R, R₁, R₂, and the alkyl group are alkyl group having 1 to 4 carbon atoms, and may be substituted with one or more fluorines (F), and n is an integer of 1 to 4.)

According to an aspect of the present disclosure, there is provided a lithium secondary battery which includes a positive electrode including a positive electrode active material; a negative electrode including a negative electrode active material; a separator located between the positive electrode and the negative electrode; and the electrolyte.

According to an aspect of the present disclosure, there is provided an electric device including the lithium secondary battery, the electric device which is a communication device, a transportation device, an energy storage device, or a sound device.

According to example embodiments of the present disclosure, the electrolyte shows a high ionic conductivity, and has a flash point of 70° C. or higher. Further, the self-extinguishing time (SET) is 0 s/g or is close to 0 s/g so that the electrolyte has an excellent flame retardancy which does not catch fire even though there is an ignition source at 30° C. and 50° C., an excellent oxidation stability to aluminum, and an excellent metal stability to a lithium metal.

Further, the electrolyte may have a high solvation ability to lithium (Li) and an anion PF₆⁻¹ of the lithium salt, enable the high power and high stable battery operations, and show excellent long-term charging/discharging characteristic and lifespan characteristic of the battery.

The effects of the present disclosure are not limited to the above-described effects, and should be understood to include all effects which may be inferred from the detailed description of the present disclosure or the configuration of the present disclosure described in the claims.

### BRIEF DESCRIPTION OF THE DRAWINGS

These and/or other aspects, features, and advantages of the disclosure will become apparent and more readily appreciated from the following description of example embodiments, taken in conjunction with the accompanying drawings of which:

FIG. 1 is a diagram illustrating an ionic conductivity at every temperature according to a type of an electrolyte using a glass fiber membrane (GFF) separator according to an example embodiment;

FIG. 2 is a diagram illustrating a voltage change experiment result of a CR2032 coin cell produced using a GFF separator, for every charging/discharging count (time: one count=one hour) according to a type of electrolyte according to an example embodiment;

FIG. 3 is a diagram illustrating a voltage change experiment result of a CR2032 coin cell produced using a celgard 2320 separator, for every charging/discharging count according to a type of electrolyte according to an example embodiment;

FIG. 4 is a diagram of comparing voltage changes for every charging/discharging count of an asymmetric carbonate MEMC electrolyte and a symmetric carbonate BMEC, for a coin cell produced using a celgard 2320 separator according to an example embodiment;

FIG. 5 is a diagram illustrating impedance spectroscopy (EIS) and chronoamperometry (CA) analysis results of each type of electrolytes, BMEC, DBC, and EC/DEC, used for a coin cell according to an example embodiment;

FIG. 6 is a diagram illustrating a result of evaluating an oxidation stability for an aluminum foil according to types of electrolytes EC/DEC, DBC, BMEC, B7E3, and B1E1 according to an example embodiment;

FIG. 7 is a diagram illustrating a result of checking a reactivity with a lithium (lithium metal stability), with colors, by immersing a lithium chip in each electrolyte of EC/DEC, BMEC, and DBC for 16 days according to an example embodiment;

FIG. 8 is a diagram illustrating a result of measuring ⁷Li NMR spectrum to observe a solvation structure of a solution in which 1 M of LiPF₆ is dissolved in each solvent of DBC, BMEC, and DEC according to an example embodiment;

FIG. 9 is a diagram illustrating a result of measuring FTIR to observe a solvation structure of PF₆⁻¹ anion of a solution in which 1 M of LiPF₆ is dissolved in each solvent of DEC, DBC and BMEC according to an example embodiment;

FIG. 10 is a diagram illustrating a result of measuring a discharge capacity of a half cell produced using NMC811 as a positive electrode and GFF as a separator and using EC/DEC, DBC, BMEC, and B7E3 electrolytes according to a charging/discharging cycle according to an example embodiment;

FIG. 11 is a diagram illustrating a result of measuring a discharge capacity of a half cell produced using carbon-coated graphite (ccGr) as a positive electrode and GFF as a separator and using EC/DEC, DBC, BMEC, and B7E3 electrolytes according to a charging/discharging cycle according to an example embodiment;

FIG. 12 is a diagram illustrating a result of measuring a discharge capacity of a half cell produced using ccGr as a positive electrode and GFF as a separator and using an MEMC electrolyte according to a charging/discharging cycle according to an example embodiment;

FIG. 13 is a diagram illustrating a result of measuring a discharge capacity of a half cell produced using NMC622 as a positive electrode and celgard as a separator and using B7E3+VC and EC/DEC according to a charging/discharging cycle at 50° C. according to an example embodiment;

FIG. 14 is a diagram illustrating a result of measuring a discharge capacity of a CR2032 type battery using B7E3 and EC/DEC electrolytes according to a charging/discharging cycle according to an example embodiment;

FIG. 15 is a diagram illustrating a result of measuring a battery lifespan by utilizing electrolytes EC/DEC and B7E3 in which 3 vol % of FEC and 1 M of LiPF₆ are dissolved according to an example embodiment;

FIG. 16 is a diagram illustrating a result of measuring a heat flow with EC/DEC, BMEC, and B7E3 electrolytes and positive electrode powder in a CR2032 type battery using NMC811 as a positive electrode according to an example embodiment;

FIG. 17 is a diagram illustrating a comparative experiment result of a battery operation stability according to an FEC content according to an example embodiment;

FIG. 18A is a diagram illustrating a Nyquist plot of a cell including electrolytes B1E1, B6E4, and B7E3, measured for 24 hours according to an example embodiment;

FIG. 18B is a diagram illustrating a partial section of FIG. 18A according to an example embodiment;

FIG. 19 is a diagram illustrating a result of measuring a contact angle with respect to a separator according to an EC content according to an example embodiment;

FIG. 20A is a diagram illustrating a Nyquist plot of a cell including electrolytes B7E3 and dual B7E3, measured for 24 hours according to an example embodiment; and

FIG. 20B is a diagram illustrating a partial section of FIG. 20A according to an example embodiment.

### DETAILED DESCRIPTION

Hereinafter, example embodiments will be described in detail with reference to the accompanying drawings. However, various changes may be applied to the example embodiments so that the scope of the application is not restricted or limited by the example embodiments. It should be understood that all changes, equivalents, or substitutes of example embodiments are included in the scope of the rights.

Terms used in the example embodiment are used only for illustrative purposes only, but should not be interpreted as an intention to limit the disclosure. A singular form may include a plural form if there is no clearly opposite meaning in the context. In the present specification, it should be understood that terminology “include” or “have” indicates that a feature, a number, a step, an operation, a component, a part or the combination those of described in the specification is present, but do not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms defined in generally used dictionary shall be construed that they have meanings matching those in the context of a related art, and shall not be construed in ideal or excessively formal meanings unless they are clearly defined in the present application.

In description with reference to accompanying drawings, the same components are denoted by the same reference numerals regardless of the reference numeral and a duplicated description thereof will be omitted. In description of an example embodiment, if it is determined that detailed description for a related art may unnecessarily blur the gist of the example embodiment, the detailed description will be omitted.

According to an example embodiment of the present disclosure, provided is an electrolyte containing a linear organic carbonate compound represented by Chemical Formula 1, an electrolyte additive, and a lithium salt.

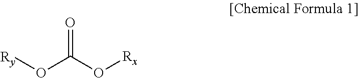

(In Chemical Formula 1, Rₓ and R_{y} each includes at least one selected from the group consisting of an alkoxyalkyl group represented by the following Chemical Formula 2, an alkyl sulfanyl group represented by the following Chemical Formula 3, an alkyl amino group represented by the following Chemical Formula 4, and an alkyl group,

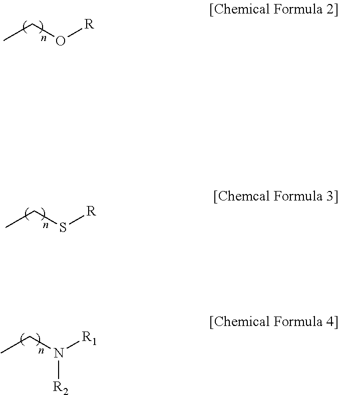

In Chemical Formulae 1 to 4, R, R₁, R₂, and the alkyl group are alkyl group having 1 to 4 carbon atoms, and may be substituted with one or more fluorine (F), and n is an integer of 1 to 4.)

In the present specification, the linear organic carbonate refers to an acyclic carbonic compound and may refer to a compound which does not have a cyclic structure and includes a carbonate group (carboxyl group, —CO₃).

Specifically, the linear organic carbonate compound may refer to a compound represented by Chemical Formula 1, and various types of compounds may be included in the linear organic carbonate compound according to the example embodiment of the present disclosure, according to a type of substitute defined above.

Specifically, desirably, the substituent is a substituent including an alkoxyalkyl group, an alkyl sulfanyl group, and an alkyl amino group, and accordingly, the linear organic carbonate compound may be bis(2-methoxyethly) carbonate (BMEC), (2-methoxyethyl) methyl carbonate (MEMC) and (2-methoxyethyl) ethyl carbonate (MEEC).

In the meantime, the electrolyte according to the example embodiment of the present disclosure has a flash point of 70° C. or higher, and shows an ionic conductivity of 0.05 mS/cm or higher at a room temperature in a commercial separator condition formed of polypropylene (PP) or a combination of polypropylene and polyethylene (PE).

Further, the electrolyte according to the example embodiment of the present disclosure may have a self-extinguishing time (SET) which is 0 s/g or a value close thereto. The self-extinguishing time is a value obtained by measuring a time after putting a predetermined amount of electrolyte on a stainless steel plate when the electrolyte is in contact with a gas burner for 3 seconds or longer to be ignited and then extinguished by itself. It is represented with a time (s) per unit mass (g).

When the self-extinguishing time is 0 s/g, it means that even in contact with an ignition source for 3 seconds or longer, the fire is not caught. The flame retardancy of the electrolyte according to the example embodiment of the present disclosure is significantly improved by reducing the self-extinguishing time as compared with the existing commercial electrolyte so that when the electrolyte is used for a lithium secondary battery, the possibility of the fire and thermal runaway of the battery may be significantly lowered.

In the meantime, at least one of Rₓ and R_{y}, among the linear organic carbonate compounds represented by Chemical Formula 1, included in the electrolyte, may include one or more substituents selected from the group formed of Chemical Formulae 2 to 4.

That is, it may mean that a compound in which both Rₓ and R_{y} simultaneously correspond to the alkyl group is not included in the range of the linear carbonate according to the example embodiment of the present disclosure.

In the meantime, Rₓ and R_{y} include one or more selected from the group consisting of an alkoxyalkyl group, an alkyl sulfanyl group, an alkyl amino group, and an alkyl group listed above so that the linear organic carbonate represented by Chemical Formula 1 may be symmetric or asymmetric.

As described above, Rₓ and R_{y} cannot simultaneously correspond to the alkyl group so that only in the asymmetric linear organic carbonate, the alkyl group may be included in one of Rₓ and R_{y}.

All the alkoxyalkyl group, the alkyl sulfanyl group, and the alkyl amino group listed above are polar functional groups so that the linear organic carbonate includes the functional group so that the interaction between molecules is significant. Accordingly, a vapor which affects the flash point is reduced, to show the flame retardancy characteristic.

The electrolyte according to the example embodiment of the present disclosure may additionally substitute the alkyl group, R, R₁, or R₂ which constitutes the organic linear carbonate compound with fluorine (F), thereby forming mono-, di-, and tri-fluoroalkyl.

Further, the electrolyte additive may include one or more selected from the group consisting of fluoroethylene carbonate (FEC), vinylene carbonate (VC), vinyl ethylene sulfite, and vinyl ethylene carbonate, and an added content of the electrolyte additive may be 10 vol % or less based on the total electrolyte. When the content of the expensive electrolyte additive exceeds 10 vol %, an electrolyte producing cost is excessively increased, an ion transfer and interfacial resistance are increased, and the side reaction with other components in the electrolyte may be caused to degrade the cell performance.

Specifically, the electrolyte additive type used according to the example embodiment of the present disclosure is fluoroethylene carbonate (FEC). At this time, the added amount may be 1 vol % or more and less than 4 vol %, desirably 3 vol % so that the stable electrodeposition of lithium is continuously possible, which enables the stable operation of the battery.

In the meantime, the electrolyte according to the example embodiment of the present disclosure includes a lithium salt, and the lithium salt may be included in a concentration of 0.5 M to 2 M, and desirably, 0.8 M to 2 M, or 1 M to 2 M. When the concentration of the lithium salt is less than 0.5 M, the ionic conductivity is reduced, which may degrade the electrochemical performance of the lithium secondary battery including the lithium salt. When the concentration of the lithium salt exceeds 2 M, the lithium salt is not sufficiently dissolved to increase the viscosity of the electrolyte, which may degrade the ionic conductivity and causes an increase in the producing cost.

Further, a specific type of the lithium salt may correspond to one or more selected from the group consisting of lithium hexafluorophosphate (LiPF₆), lithium bis(trifluoromethanesulfonyl)imide (LiTFSI), lithium bis(fluorosulfonyl)imide (LiFSI), lithium difluorophosphate, lithiumdifluoro(bisoxalato)phosphate, and lithium bis(oxalate)borate.

Specifically, the lithium salt may be desirably used in conjunction with LiPF₆ and a lithium salt having a large anion (dual lithium salt) in terms of the high ionic conductivity. And as a specific example, one combination selected from the group consisting of lithium hexafluorophosphate (LiPF₆), lithium bis(trifluoromethanesulfonyl)imide (LiTFSI), lithium bis(fluorosulfonyl)imide (LiFSI), lithium difluorophosphate, lithiumdifluoro(bisoxalato)phosphate, and lithium bis(oxalate)borate may be used.

Further, to be more specific, a combination of LiPF₆ and LiTFSI may be more desirably used.

The electrolyte according to the example embodiment of the present disclosure may further include a solvent containing a cyclic carbonate, in addition to the linear organic carbonate compound.

Specifically, the cyclic carbonate may include one or more of ethylene carbonate (EC) and propylene carbonate (PC), and when the cyclic carbonate such as EC or PC and the above-described linear organic carbonate compound are mixed to be used, a content volume ratio of the linear organic carbonate to the cyclic carbonate may be greater than 6:4 and less than or equal to 10:0.

When a content volume ratio of the linear organic carbonate to the cyclic carbonate is 6:4 or less (that is, 5:5 and 4:6), a large amount of cyclic carbonate such as EC is contained, so that the wettability of the electrolyte to a commercial polyolefin-based separator may be degraded. In the meantime, the commercial polyolefin-based separator may be a commercial separator formed of polypropylene (PP) or a combination of polypropylene and polyethylene (PE) and specifically, as an example, a celgard separator used for the following example embodiment may be used.

In the meantime, according to the example embodiment of the present disclosure, a lithium secondary battery including the electrolyte which has been described in detail above is provided.

The lithium secondary battery includes a positive electrode including a positive electrode active material, a negative electrode including a negative electrode active material, and a separator located between the positive electrode and the negative electrode, and the positive electrode may be a positive electrode including a lithium transition metal oxide or a lithium transition metal phosphate, and the negative electrode may include graphite, a silicon based active material or a mixture thereof.

According to the example embodiment of the present disclosure, an electric device including the lithium secondary battery is provided.

The electric device may correspond to a communication device, a transportation device, an energy storage device, or a sound device.

Hereinafter, a configuration of the present disclosure and an effect thereof will be described in detail with reference to Example Embodiments and Comparative Examples. However, the following Example Embodiments are set forth to illustrate the present disclosure, but the scope of the present disclosure is not limited thereto.

### EXAMPLE EMBODIMENTS

### 1. Experimental Example 1: Measure Boiling Point, Flash Point, and Self-Extinguishing Time (SET) of Various Types of Electrolyte Solvents

Boiling points, flash points, and self-extinguishing times of diethyl carbonate (DEC), dibutyl carbonate (DBC), ethylene carbonate (EC), and EC/DEC (1:1, v/v) which were existing comparative solvents and bis(2-methoxyethyl) carbonate (BMEC), (2-methoxyethyl) methyl carbonate (MEMC), (2-methoxyethyl) ethyl carbonate (MEEC), and EC/BMEC (3:7, v/v), EC/BMEC (1:1, v/v), and EC/MEMC (1:1, v/v) according to the example embodiment of the present disclosure were measured and results thereof are represented in the following Table 1.

TABLE 1

| | Boiling | Flash | SET | SET |
|---|---|---|---|---|
| | point | point | (s/g), | (s/g), |
| Solvent | (° C.) | (° C.) | 30° C. | 50° C. |
| DEC | 128 | 31 | 63.6 | 80.4 |
| DBC | 208 | 86 | Zero | Zero |
| BMEC | 232 | 121 | Zero | Zero |
| EC/BMEC (3:7 v/v) | — | 127 | — | — |
| EC/BMEC (1:1 v/v) | — | 131 | — | — |
| MEMC | 172 | 73 | Zero | Zero |
| EC/MEMC(1:1 v/v) | — | 87 | — | — |
| MEEC | 185 | 76 | Zero | Zero |
| EC | 248 | 145 | — | — |
| EC/DEC (1:1 v/v) | — | 40 | — | — |

Flash points of BMEC, MEMC, MEEC, and a mixed solvent obtained by mixing each of them with EC were increased to 70° C. or higher, and all the self-extinguishing times (SET) were 0 s/g so that it was confirmed that it had a flame retardancy characteristic that did not catch fire when there was an ignition source at 30° C.

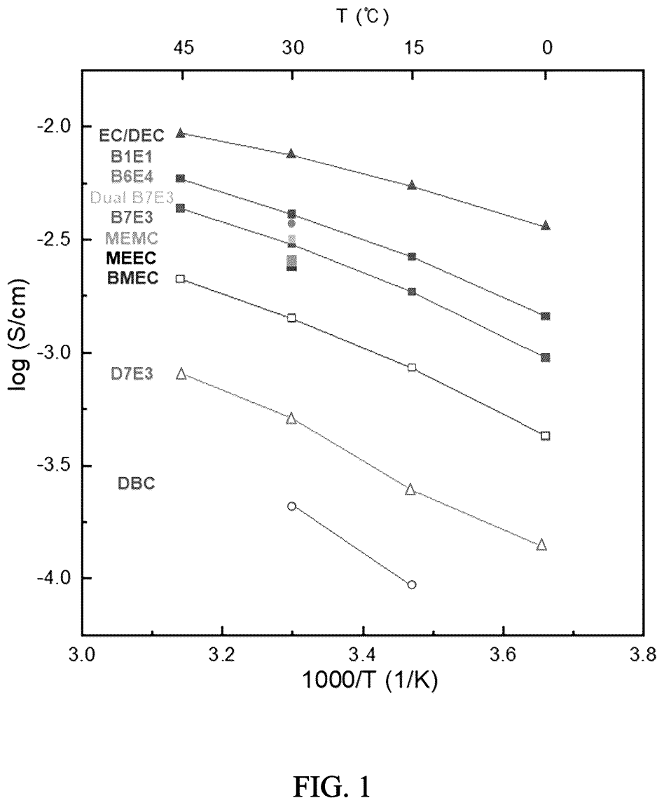

### 2. Experimental Example 2: Analysis of Ionic Conductivity Using Glass Fiber Membrane (GFF) as Separator (FIG. 1)

A CR2032 coin cell was produced by using stainless steel current collectors as a positive electrode and a negative electrode, a glass fiber membrane (GFF) with a thickness of 0.3 mm as a separator, and a solvent in which 1 M of LiPF₆ and 3 vol % of FEC were dissolved as an electrolyte.

(EC/DEC (1:1, v/v) (hereinafter, represented by “EC/DEC”), BMEC/EC (1:1, v/v) (hereinafter, represented by “B1E1”), BMEC/EC (6:4 v/v) (hereinafter, represented by “B6E4”), BMEC/EC (7:3, v/v) (hereinafter, represented by “B7E3”), MEMC, MEEC, BMEC, DBC/EC (7:3, v/v) (hereinafter, represented by “D7E3”), and DBC)

A CR2032 coin cell was produced by changing only the electrolyte to an electrolyte (hereinafter, represented by “dual B7E3”) in which two salts of 0.5 M-LiPF₆ and 0.5 M-LiTFSI were dissolved in BMEC/EC (7:3, v/v) solvent.

All the electrochemical impedance spectroscopy (EIS) analysis was conducted in the frequency range of 300 mHz to 1 MHz at 45° C., 30° C., 15° C., and 0° C., respectively, and a result thereof is represented in FIG. 1.

Referring to FIG. 1, it was confirmed that a conductivity of the BMEC electrolyte was higher than a conductivity of the DBC electrolyte at all measured temperatures, and the ionic conductivities were at the similar level of the commercial electrolyte in the order of B7E3, B6E4, and B1E1 whose ratio of EC in the electrolyte was increased. It was further confirmed that the conductivity of the dual B7E3 electrolyte which used two salts was higher than a conductivity of B7E3 which is a single salt, and the ionic conductivities of the asymmetric MEMC electrolyte and MEEC electrolyte were higher than the ionic conductivity of the symmetric BMEC electrolyte.

### 3. Experimental Example 3: Analysis of Electrochemical Characteristic

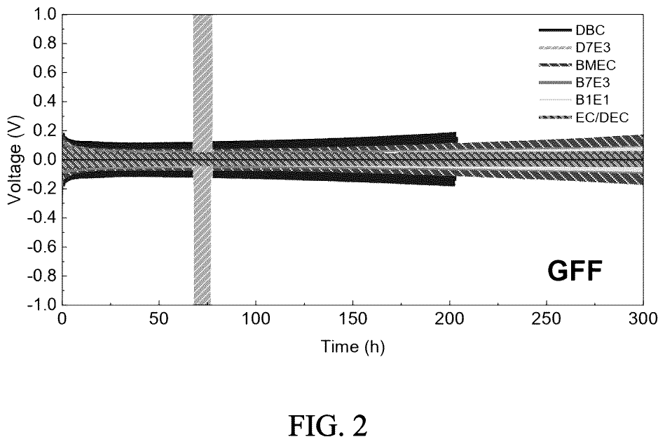

### (1) Experimental Example 3-1: Produce CR2032 Coin Cell Using GFF Separator and Analyze Characteristic (FIG. 2)

A CR2032 coin cell was produced by punching a lithium metal chip to have a diameter of 11.3 mm (area was 1.003 m⁻²) to be used as a positive electrode and a negative electrode, respectively, and using a GFF of a thickness of 0.3 mm as a separator, and DBC, D7E3, BMEC, B7E3, B1E1, and EC/DEC obtained by adding 1 M of LiPF₆ and 3 vol % of FEC as electrolytes.

A charging/discharging cycle of applying a constant current density of 1 mA·cm⁻² for 30 minutes at a temperature of 30° C. was continuously repeated, and the charging/discharging cycle was set to stop when the cell collapsed to reach a voltage of 1.0 V. The result is illustrated in FIG. 2.

Referring to FIG. 2, it was confirmed that all the lithium symmetric cells which used an electrolyte including BMEC was stably operated while maintaining an overvoltage of 0.2 V or lower up to 300 cycles or more. Specifically, when EC was included, the overvoltage was reduced to a level of 0.1 V or lower, to be stably maintained.

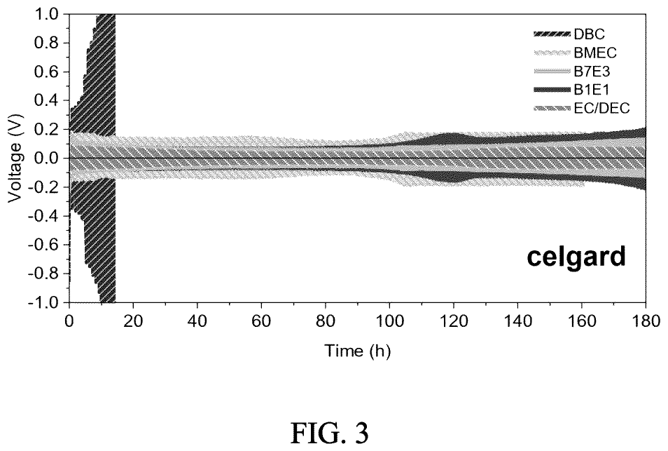

### (2) Experimental Example 3-2: Produce CR2032 Coin Cell Using Celgard 2320 Separator and Analyze Characteristic (FIG. 3)

Experiment was conducted in the same way as Experimental Example 3-1 except that a celgard 2320 separator was used and the result is illustrated in FIG. 3.

Referring to FIG. 3, it was confirmed that all the lithium symmetric cells using an electrolyte including BMEC was stably operated while maintaining an overvoltage of 0.2 V or lower up to 100 cycles or more. Accordingly, it was understood that an electrolyte including BMEC was stable even at a low voltage of −0.2 V as compared with a lithium metal, regardless of the type of separator, and the electrolyte was stably combined with a lithium metal and a lithium ion battery negative electrode to be utilized.

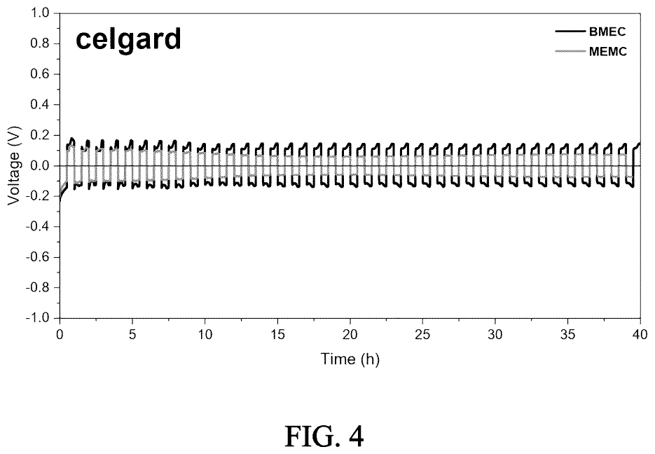

### (3) Experimental Example 3-3: Produce CR2032 Coin Cell Using Celgard 2320 Separator and Analyze Characteristic (FIG. 4)

The experiment was conducted in the same way as Experimental example 3-2 except that the asymmetric carbonate MEMC electrolyte was used, and a result obtained by comparing with the BMEC electrolyte is illustrated in FIG. 4.

Referring to FIG. 4, it was understood that even though the MEMC electrolyte reversibly occurred a charging/discharging reaction when it was repeated for 30 hours or longer, the MEMC electrolyte had an overvoltage which was 0.04 V lower than that of the symmetric BMEC. By doing this, it was understood that the MEMC may be more stably combined with the lithium metal and the lithium ion battery negative electrode, than the symmetric BMEC.

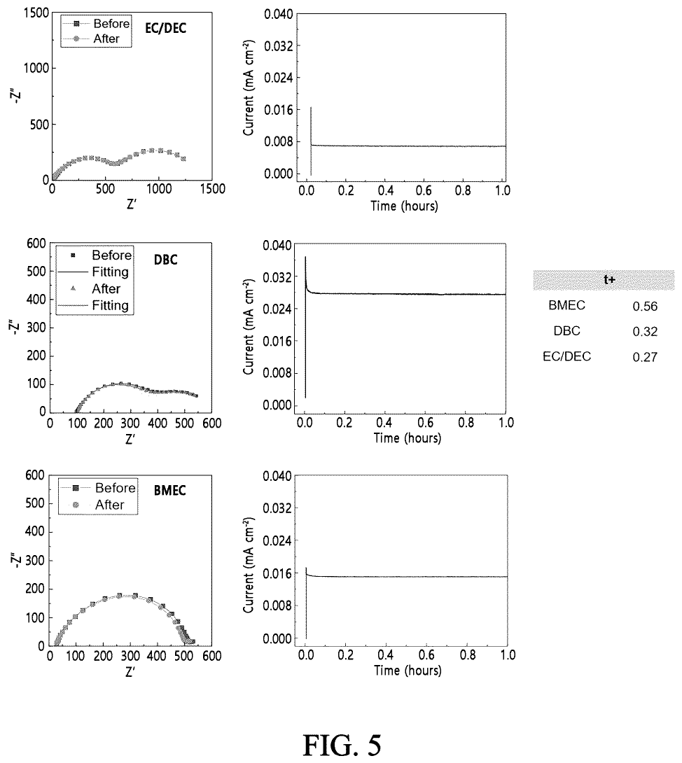

### 4. Experimental Example 4: EIS, CA Analysis (FIG. 5)

A CR2032 coin cell was produced by punching a lithium metal chip to have a diameter of 11.3 mm to be used as a positive electrode and a negative electrode, and GFF as a separator, and an electrolyte in which 1 M of LiPF₆ and 3 vol % of FEC were contained in EC/DEC, DBC, and BMEC solvents for the cell.

The impedance spectroscopy (EIS) analysis was conducted while applying a 10 mV of voltage in the range of 100 kHz to 1 Hz, and the chronoamperometry (CA) analysis was conducted while applying a voltage of 10 mV for one hour.

By doing this, a yield (transference number) of lithium cations was obtained through a resistance and current values of initial and steady-states in each cell, and BMEC, DBC, and EC/DEC showed 0.56, 0.32, and 0.27, respectively. The result thereof is illustrated in FIG. 5.

Referring to FIG. 5, it was understood that among various ion types which were transferred into the electrolyte, a ratio of the lithium cation which was transferred in the BMEC electrolyte was highest, and the BMEC electrolyte was more appropriate for high power and high stable battery operation, as compared with DBC and EC/DEC.

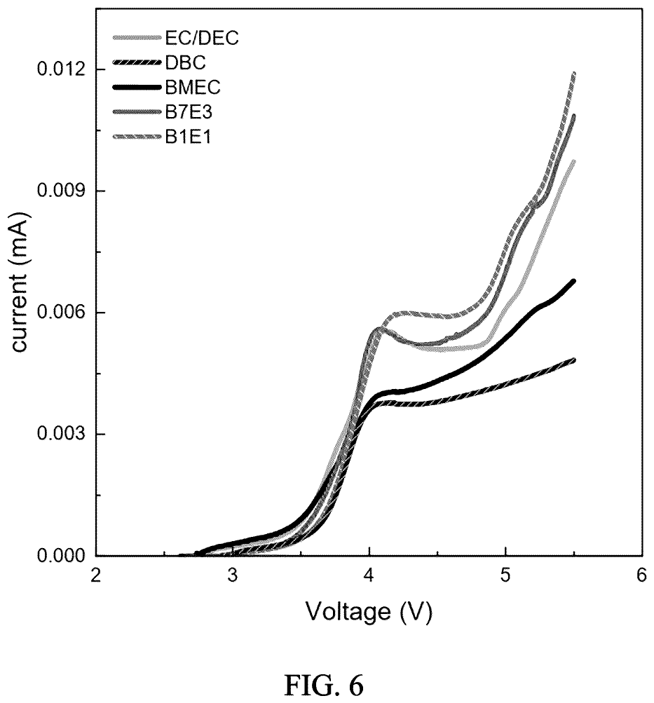

### 5. Experimental Example 5: Evaluate Oxidation Stability (FIG. 6)

A CR2032 coin cell was produced by punching an aluminum foil to have a diameter of 16 mm to be used as a positive electrode, punching a lithium metal chip to have a diameter of 11.3 mm to be used as a negative electrode, and using the GFF as a separator.

An upper charging voltage was set to 3.5 V and a lower discharging voltage was set to an open circuit voltage (OCV) at a temperature of 30° C. to charge and discharge for three cycles at a constant voltage of 5 mV/s in this range. Thereafter, it was charged with a constant voltage of 1 mV/s from OCV to 5.5 V to evaluate the oxidation stability for the aluminum foil.

The result was represented in FIG. 6 and in the cell, EC/DEC, DBC, BMEC, B7E3, and B1E1 electrolytes including 1 M of LiPF₆ and 3 vol % of FEC were used, respectively.

As illustrated in FIG. 6, in all the coin cells using the electrolyte, an oxidation current started to rapidly increase from 3.4 V, which indicated that even though a length of a chain of the linear organic carbonate according to the example embodiment of the present disclosure was increased and an ether group was added, all the coin cells were stable in the commercial battery operation condition without significantly changing the oxidation stability of the electrolyte.

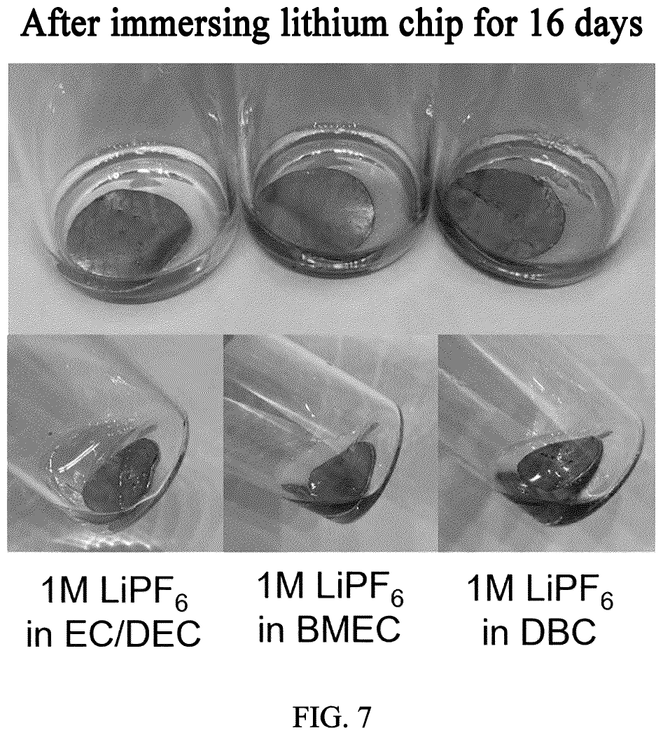

### 6. Experimental Example 6: Evaluate Lithium Metal Stability (FIG. 7)

Pieces of lithium metal were immersed in each electrolytes EC/DEC, BMEC, and DBC in which 1 M of LiPF₆ was dissolved and then stored in a glove box for 16 days, and a color change of the electrolyte was observed.

As illustrated in FIG. 7, it was confirmed that the DBC electrolyte chemically reacted with a lithium metal so that a color of the electrolyte was changed to yellow, and the BMEC electrolyte was slightly discolored to yellow, but it was not severe.

By doing this, it was understood that even in a single composition of the linear organic carbonate according to the example embodiment of the present disclosure, the stability to the lithium metal may be secured.

### 7. Experimental Example 7: Observe Solvation Structure

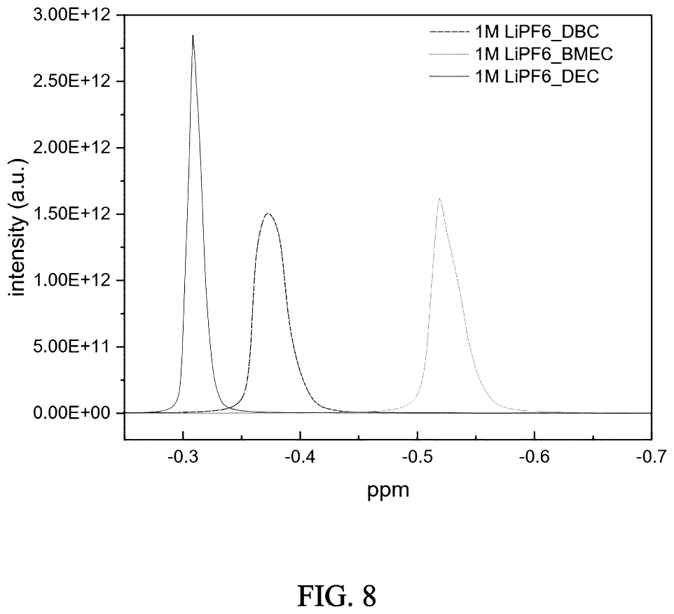

### (1) Experimental Example 7-1: Observe Solvation Structure by NMR Analysis (FIG. 8)

In order to observe a solvation structure of a solution in which 1 M of LiPF₆ was dissolved in solvents DEC, DBC, and BMEC, 7 Li NMR was analyzed, and a result is illustrated in FIG. 8.

The better the solvation, the higher the electron density around Li so that a peak tended to be upfielded (a direction of decreasing a ppm value) due to the shielding effect, and from FIG. 8, it was understood that the peaks were upfielded in the order of BMEC, DBC, and DEC.

That is, it means that as compared with DBC and DEC, the BMEC molecule effectively solvates the lithium through the ether group to secure a high flash point and a high ionic conductivity.

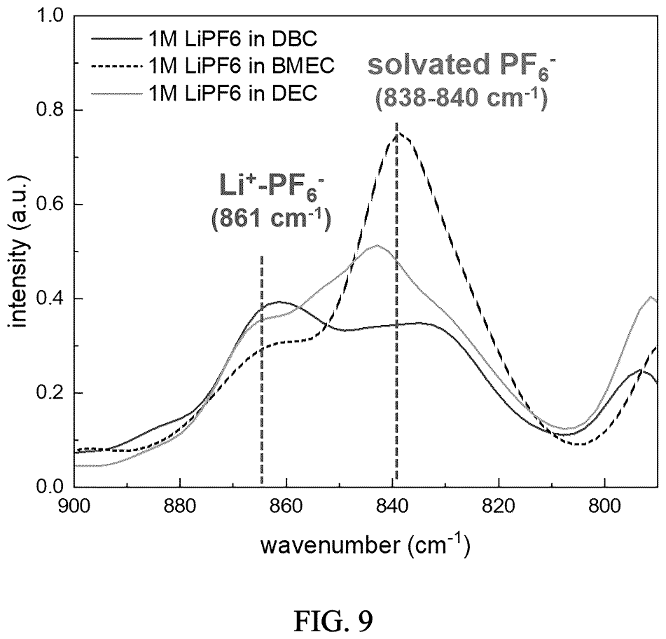

### (2) Experimental Example 7-2: Observe Solvation Structure by FTIR Analysis (FIG. 9)

In order to observe a solvation structure of PF₆⁻¹ anion of solvents DEC, DBC and BMEC in which 1 M of LiPF₆ was dissolved, the FTIR analysis was conducted, and the result is illustrated in FIG. 9.

861.8 cm⁻¹ indicates a coupling of Li ion and PF₆⁻¹, and 838.2 cm⁻¹ indicates a solvated PF₆⁻¹.

Referring to FIG. 9, it was understood that in the case of a solution using BMEC, a peak intensity of the solvated PF₆⁻¹ anion was stronger than that coupled with the Li ion. Further, it was confirmed that the solution using DBC had almost similar peak intensity, but the peak intensity of the PF₆⁻¹ coupled with the Li ion was slightly higher.

This means that the BMEC solvent dissociates an LiPF₆ salt more than the DEC and DBC solvent, which means that it is helpful to improve the ionic conductivity and the yield (transference number) of the lithium cation.

### 8. Experimental Example 8: Evaluation Result of Electrochemical Characteristic

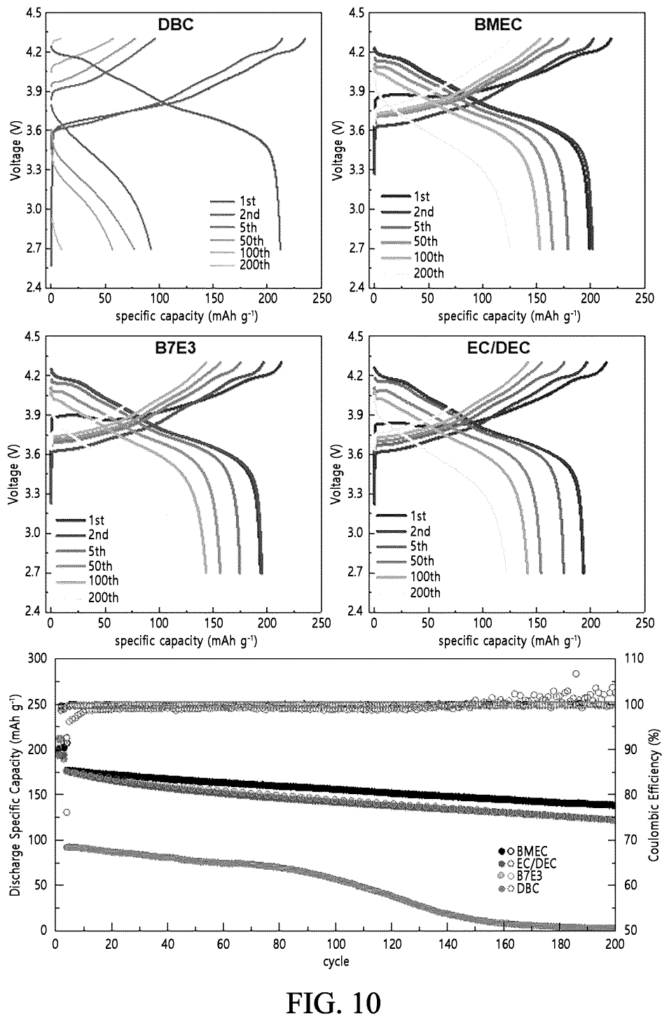

### (1) Experimental Example 8-1 (FIG. 10)

A CR2032 type half cell was produced by punching NMC 811 to have a diameter of 11.3 mm to be used as a positive electrode and punching a lithium metal chip to have a diameter with 11.3 mm to be used as a negative electrode, punching the GFF as a separator, and using EC/DEC, DBC, BMEC, and B7E3 electrolytes, respectively, having 1 M of LiPF₆ and 3 vol % of FEC. The half cell was charged/discharged with a current density of 0.1 C for three cycles in a range of an upper charging voltage of 4.3 V, and a lower discharging voltage of 2.7 V at a temperature of 30° C., and then with a current density of 0.5 C to evaluate the electrochemical characteristic (FIG. 10).

The DBC battery was charged/discharged with a discharge capacity of 91.9 mAh/g or lower from a fourth cycle, and charged/discharged by 55.4% of an initial discharge capacity of 50 mAh/g or lower from a 107-th cycle.

The BMEC battery was reversibly charged/discharged while maintaining a discharge capacity of 135 mAh/g which was 77.9% or higher of an initial discharge capacity to a 200-th cycle.

The B7E3 battery showed a discharge capacity of 121.1 mAh/g which was similar to 122.4 mAh/g of a discharge capacity of the commercial electrolyte at the 200-th cycle.

By doing this, it is understood that when an NMC 811 positive electrode and an electrolyte including BMEC were used, the stable operation is possible, like the existing commercial electrolyte.

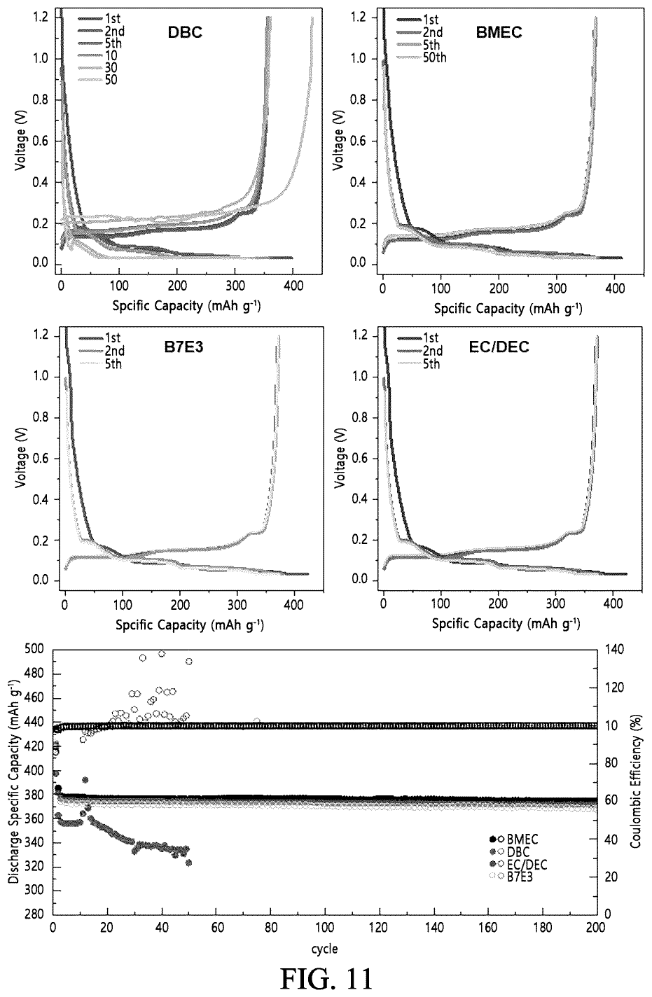

### (2) Experimental Example 8-2 (FIG. 11)

A CR2032 type half cell was produced by punching carbon-coated graphite (ccGr) to have a diameter of 11.3 mm to be used as a positive electrode, punching a lithium metal chip to have a diameter of 11.3 mm to be used as a negative electrode, and using the GFF as a separator, and using each of EC/DEC, DBC, BMEC, and B7E3 electrolytes having 1 M of LiPF₆ and 3 vol % of FEC.

An upper charging voltage of the half cell was set to 1.2 V and a lower discharging voltage was set to 30 mV at a temperature of 30° C., and a constant voltage condition in which a voltage was constantly maintained until it reached to 1/10 of each current density was also applied. The electrochemical characteristic was evaluated by charging/discharging for two cycles with a current density of 0.2 C and then a current density of 0.5 C (FIG. 11).

The DBC battery was reduced to 90.5% of the initial discharge capacity at the 50-th cycle to be charged/discharged without maintaining the discharge capacity of 397.3 mAh/g which was an initial capacity after a 12-th cycle.

The BMEC battery had a coulombic efficiency of 99% or higher to a 50-th cycle and showed a discharge capacity of 364.9 mAh/g which was 99% of the initial discharge capacity.

The B7E3 battery showed a discharge capacity of 374.7 mAh/g which was similar to 376.7 mAh/g which was a discharge capacity of the commercial electrolyte to the 20-th cycle.

By doing this, it was understood that when the ccGr electrode and an electrolyte including BMEC were used, the stable operation was possible, like the existing commercial electrolyte.

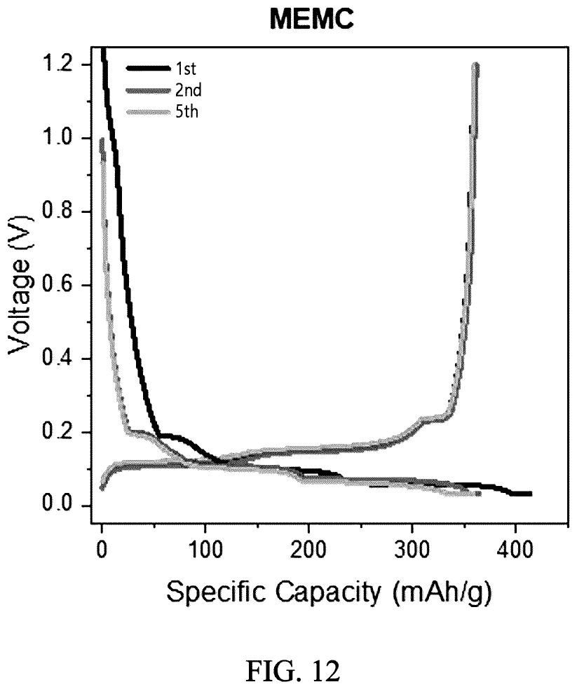

### (3) Experimental Example 8-3 (FIG. 12)

The experiment was conducted in the same way as Experimental Example 8-2 except that as the electrolyte MEMC to which 3 vol % of FEC was added was used to evaluate the electrochemical characteristic (FIG. 12).

When the battery was charged/discharged for 5 cycles, the MEMC electrolyte showed the discharge capacity of 359.4 mAh/g so that it was understood that not only BMEC which was the symmetric carbonate, but also the asymmetric MEMC electrolyte were used together with the ccGr electrode, the stable operation may be achieved.

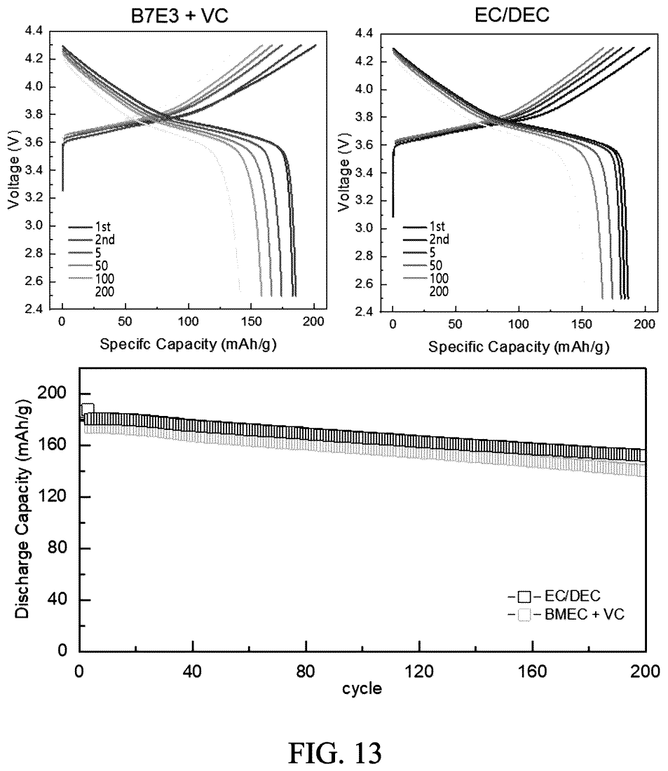

### (4) Experimental Example 8-4 (FIG. 13)

Each of a CR2032 type half cell was produced by punching NMC 622 to have a diameter of 11.3 mm to be used as a positive electrode, punching a lithium metal chip to have a diameter of 11.3 mm used as a negative electrode, and using celgard as a separator, and the electrolyte to which 3 vol % of VC was added as well as the FEC, respectively, in the B7E3 electrolyte.

The half cell was charged/discharged with a current density of 0.1 C for three cycles in a range of an upper charging voltage of 4.3 V and a lower discharging voltage of 2.5 V at a high temperature of 50° C., and then charged/discharged with a current density of 0.5 C to evaluate the electrochemical characteristic at the high temperature (FIG. 13).

As a result, the B7E3 electrolyte having VC added thereto was charged/discharged while maintaining 80.9% of the initial discharge capacity up to 200-th cycle, which was a similar level as the commercial electrolyte which maintained 81.8% of the initial discharge capacity.

By doing this, it is understood that when an NMC 622 positive electrode and an electrolyte including BMEC are used, the stable operation is possible, like the existing commercial electrolyte even at the high temperature.

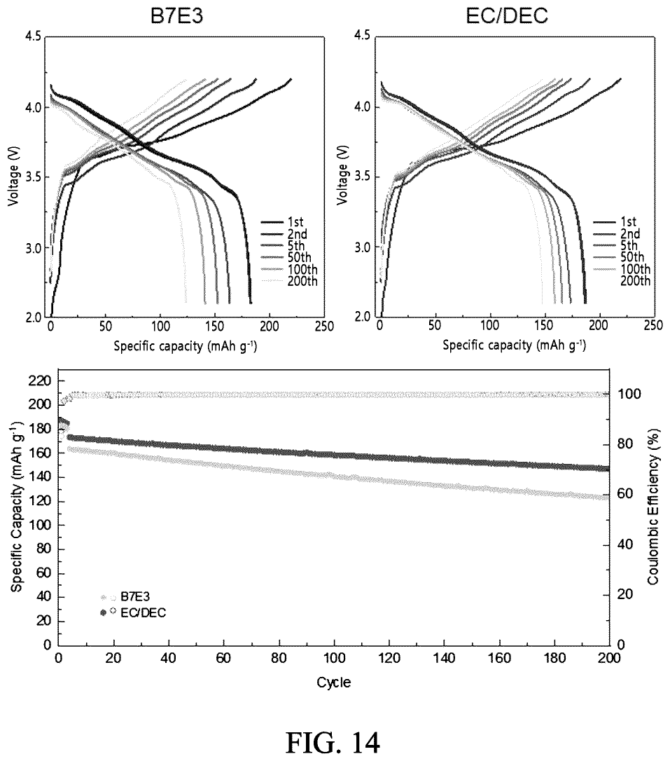

### (5) Experimental Example 8-5 (FIG. 14)

Each of a CR2032 type half cell was produced by punching NMC 811 to have a diameter of 11.3 mm to be used as a positive electrode, punching ccGr to have a diameter with 11.3 mm to be used as a negative electrode, and using the GFF as a separator, and using B7E3 and an EC/DEC electrolytes, respectively, including an FEC of 1 M of LiPF₆ and 3 vol % of FEC.

The cell was charged/discharged with a current density of 0.1 C for three cycles in a range of an upper charging voltage of 4.2 V and a lower discharging voltage of 2.6 V at a room temperature of 30° C., and then with a current density of 0.5 C to evaluate the electrochemical characteristic (FIG. 14).

As a result, it showed that the EC/DEC electrolyte maintained 84.8% of the initial discharge capacity and the B7E3 electrolyte maintained 75.1% at the 200-th cycle so that it was confirmed that both electrolytes maintained 70% or more of the initial capacity up to 200 cycles, so that it was understood that the long-term charging/discharging were possible.

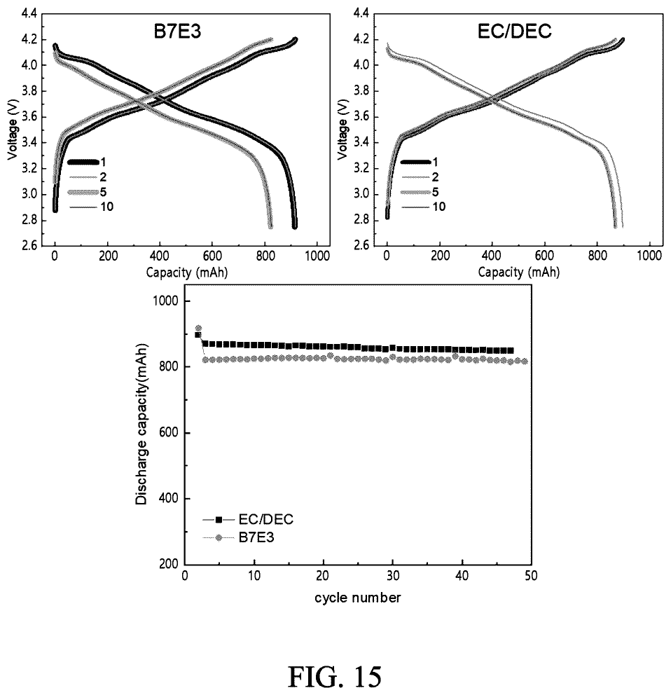

### (6) Experimental Example 8-6 (FIG. 15)

A battery was operated in each of the EC/DEC electrolyte and the B7E3 electrolyte in which 1 M of LiPF₆ and 3 vol % of FEC were dissolved, respectively, by assembling a pouch cell with NMC 811 as a positive electrode and graphite as a negative electrode. In the range of the upper charging voltage of 4.2 V and the lower discharging voltage of 2.75 V, three cycles were conducted at 0.1 C and then the lifespan was observed at 0.5 C (FIG. 15).

As a result, it was confirmed that at a 40-th cycle, 99.1% of a life span was maintained in the EC/DEC electrolyte and 99.8% of a life span was maintained in the B7E3 electrolyte at 0.5 C with respect to a 25-th cycle.

By doing this, it was understood that the B7E3 electrolyte having flame retardancy drove the battery at a similar level to the commercial electrolyte.

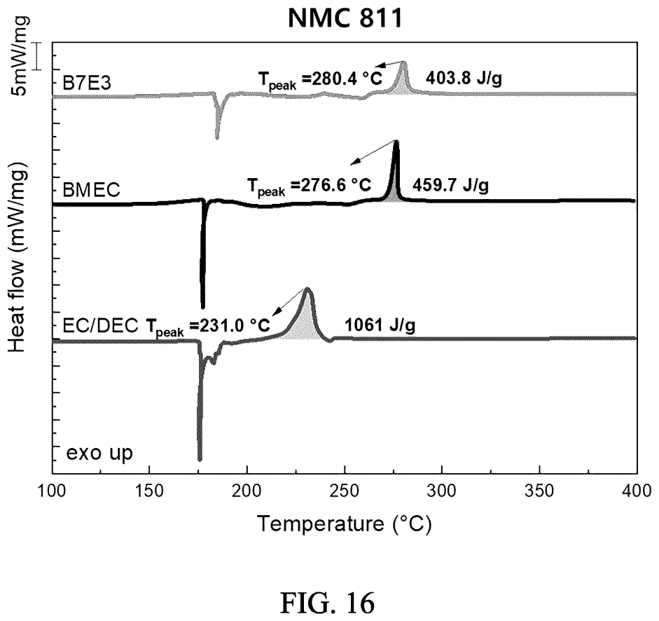

### 9. Experimental Example 9: Experiment of Confirming Flame Retardancy (FIG. 16)

A CR2032 type half cell was produced by punching NMC 811 to have a diameter of 11.3 mm to be used as a positive electrode, punching a lithium metal to have a diameter with 11.3 mm to be used as a negative electrode, and using the GFF as a separator, and using B7E3, BMEC, and EC/DEC electrolytes, respectively, including 1 M of LiPF₆ and 3 vol % of FEC.

The battery was charged/discharged for three cycles with a current density of 0.1 C in the range of an upper charging voltage of 4.3 V and a lower discharging voltage of 2.7 V at a room temperature of 30° C., and then charged up to 4.3 V.

Thereafter, after disassembling a coin cell in the glove box to scrap the positive electrode powder, 2.5 mg of the scraped electrode powder and 6 mg of electrolyte were put in an aluminum pan for DSC, and then sealed using a hermetic lid and a sealing machine to avoid the exposure to moisture and oxygen in the air. After putting the sealed aluminum lid in the DSC device and then storing for 10 minutes at 50° C., the heat flow according to a temperature change was measured by raising the temperature to 400° C. at a rate of 5° C. per minute (FIG. 16).

In the case of the NMC 811 positive electrode, heat was generated at 231° C. for EC/DEC, at 276.6° C. for BMEC, and at 280.4° C. for B7E3 so that it was confirmed that heat generation between the electrolyte and the positive electrode powder was started at a higher temperature in the BMEC included electrolyte. It was further confirmed that the amount of generated heat was generated in the order of EC/DEC, BMEC, and B7E3, and EC/DEC generated heat by 2.6 times or more than B7E3.

By doing this, it is understood that the electrolyte including BMEC shows much more excellent flame retardancy than that of the commercial electrolyte EC/DEC.

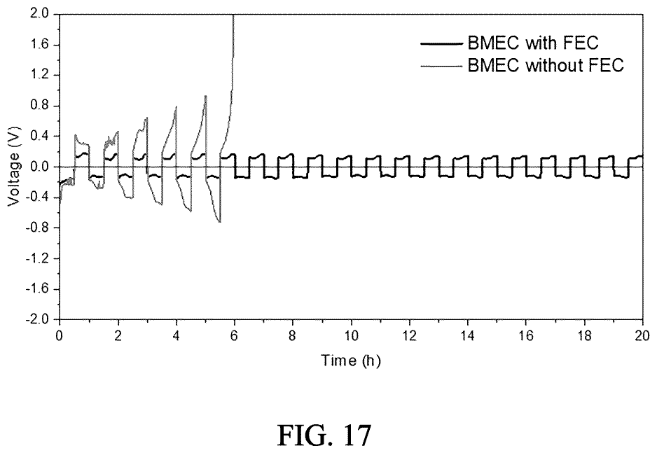

### 10. Experimental Example 10: Experiment of Comparing Battery Driving Stability According to FEC Content (FIG. 17)

A CR2032 coin cell was produced by punching the lithium metal chip to have a diameter of 11.3 mm (area was 1.003 cm⁻²) to be used as both electrodes and using celgard as a separator.

As electrolytes, a BMEC electrolyte to which 3 vol % of FEC was added and a BMEC electrolyte without FEC were used, and both electrodes included 1 M of LiPF₆.

The charging/discharging was repeated by constantly applying a current density of 1 mA·cm⁻² for 30 minutes at a temperature of 30° C. and the result was illustrated in FIG. 17.

As illustrated in FIG. 17, it was confirmed that the electrolyte with the FEC was applied with an overvoltage which was lower than 0.2 V, but the electrolyte without FEC generated an overvoltage of 0.3 V or higher. It was understood that in the lithium electrodeposition reaction, the overvoltage of the electrolyte without FEC was rapidly increased within 6 hours and an irregular voltage profile was obtained.

By doing this, it was confirmed that when the FEC was not included, the stable operation of the battery was not possible, and when 3 vol % of FEC was added, the stable lithium electrodeposition was consistently possible.

### 11. Experimental Example 11: Experiment of Changing According to Content of Cyclic Carbonate (EC)

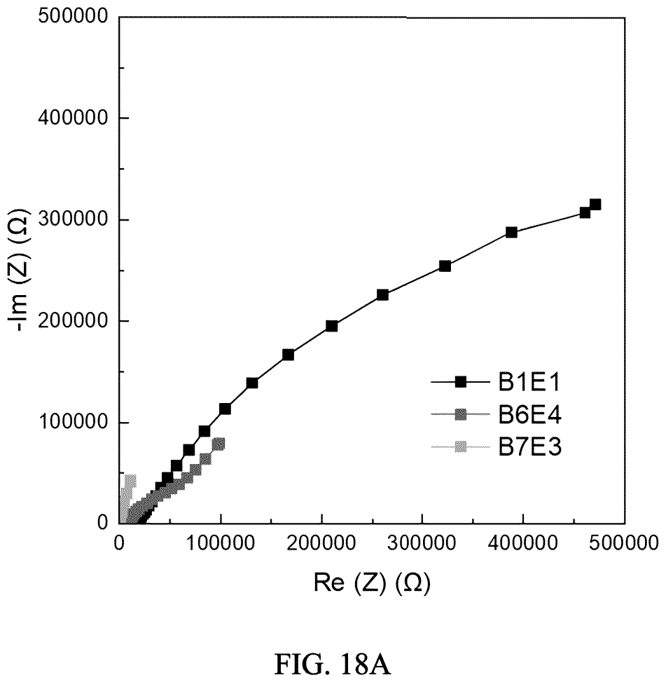

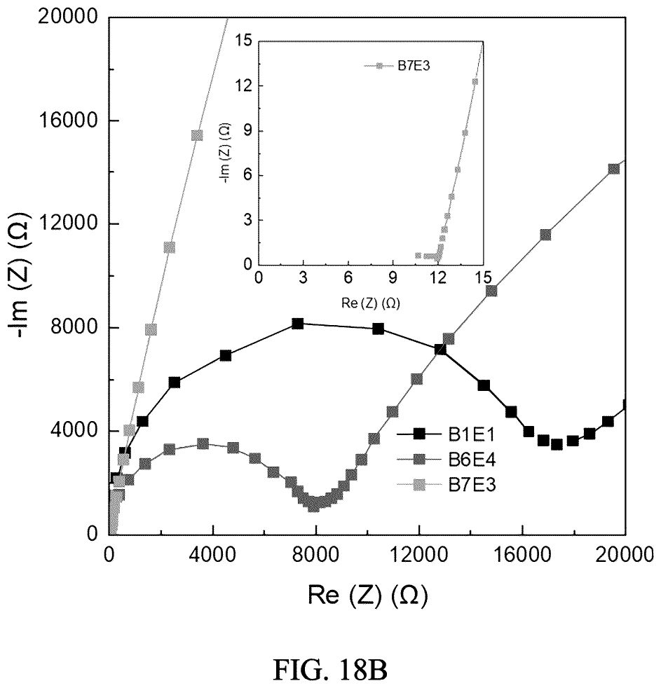

### (1) Experimental Example 11-1: Measure Ionic Conductivity Utilizing Celgard Separator (FIG. 18)

An ionic conductivity of a BMEC/EC mixed electrolyte according to an EC content in the solvent was measured at a temperature of 30° C. by utilizing celgard which was a commercial separator.

All the electrolytes included 1 M of LiPF₆ and 3 vol % of FEC additives, and BMEC:EC (7:3 v/v) (B7E3), BMEC:EC (6:4 v/v) (B6E4), and BMEC:EC (1:1 v/v) (B1E1) were used as solvents.

A CR2032 coin cell was produced using stainless steel current collectors as both electrodes and using celgard as a separator, and all the impedance spectroscopy (EIS) analysis was conducted in the frequency range of 300 mHz to 1 MHz at the temperature of 30° C.

In order to simulate a battery producing process having a rest period after injecting the electrolyte solution, Nyquist plots were repeatedly measured for 24 hours immediately after producing the cell, and a Nyquist plot which showed a lowest impedance among the results measured within 24 hours was illustrated (FIGS. 18A and 18B) and the ionic conductivity was calculated to be represented in Table 2.

TABLE 2

| Electrolyte | Celgard (mS/cm) |
|---|---|
| BMEC | 0.16 |
| B7E3 | 0.09 |
| B6E4 | 0.00013 |
| B1E1 | 0.00006 |
| EC/DEC | 0.81 |

As represented in FIGS. 18A and 18B, and Table 2, it was understood that when the celgard separator was used, as the content of the EC was increased, the ionic conductivity was rapidly reduced. Specifically, the EC was increased from 30 vol % to 40 vol % to increase the impedance by 700 times so that the ionic conductivity was reduced to 10⁷ S/cm in which the battery operation was not possible. Further, when EC was 50 vol %, the ionic conductivity was reduced to 10⁸ S/cm which was lower than the above.

By doing this, it may be confirmed that when the content of the EC is set to be less than 40 vol %, it is more advantageous to operate the battery.

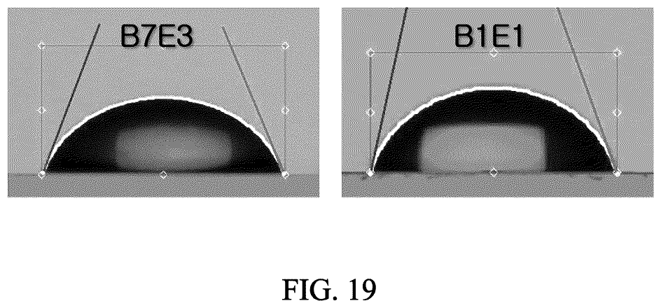

### (2) Experimental Example 11-2: Measure Wettability to Separator (FIG. 19)

Contact angles of the electrolytes B7E3 and B1E1 were measured on the celgard separator, and an angle formed with the bottom surface of the separator was measured immediately after dropping one drop of electrolyte on the separator.

As represented in FIG. 19 and Table 3, an angle formed by the separator and the electrolyte was measured to be 68° for B7E3 and 74° for B1E1, respectively, and by doing this, it was confirmed that the wettability to the separator was degraded as the content of the EC was increased.

TABLE 3

| Electrolyte | B7E3 | B1E1 |
|---|---|---|
| Contact angle | 68° | 74° |

It is determined that the difference in the wettability may affect the result that the B1E1 had 1500 times higher impedance than that of the B7E3 in the ion transfer impedance observed in Experimental Example 11-1.

Accordingly, the wettability of the electrolyte to the separator affects the ionic conductivity, the battery producing time, and the efficiency so that it is considered that the content of the EC is limited to be lower than 40 vol % to achieve the sufficient wettability, the short battery rest time, and the high ionic conductivity.

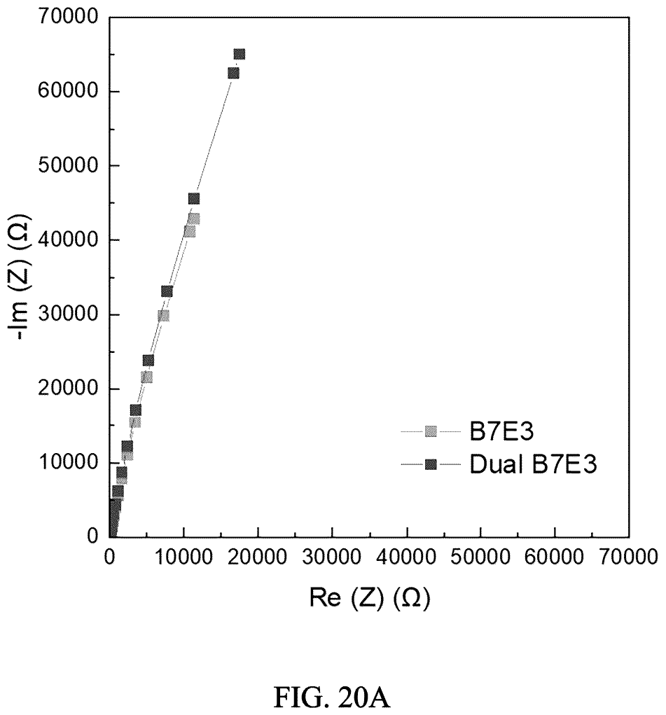

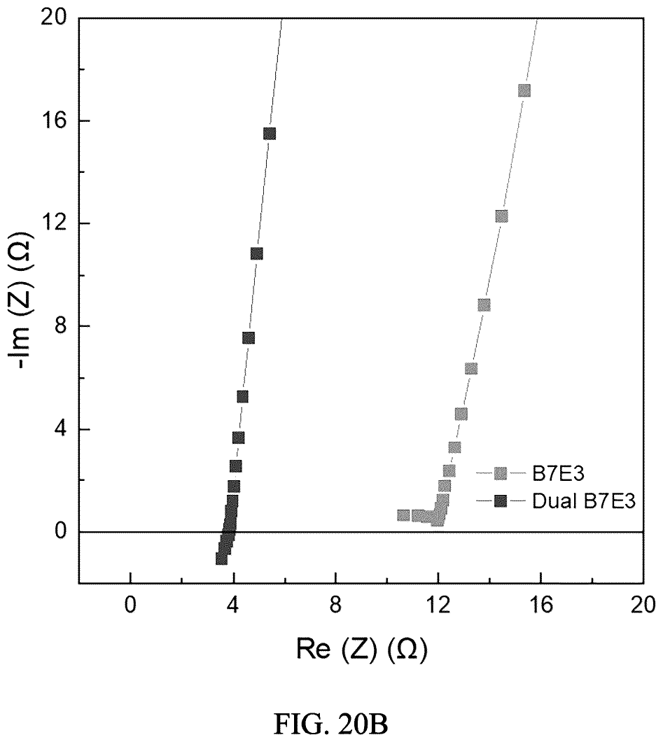

### 12. Experimental Example 12: Experiment of Ionic Conductivity Change According to Composition of Lithium Salt (FIG. 20)

In order to compare the difference of the conductivity according a composition of the lithium salt in the B7E3 electrolyte, the experiment was conducted using the electrolyte B7E3 with 3 vol % of FEC and a 1 M of LiPF₆ single salt, and an electrolyte dual B7E3 in which 0.5 M of LiPF₆ and 0.5 M LiTFSI salt were mixed together, by the following method.

A CR2032 coin cell was produced using stainless steel current collectors as both electrodes, and using celgard and GFF as separators, respectively, and all the impedance spectroscopy (EIS) analysis was conducted in the frequency range of 300 mHz to 1 MHz at the temperature of 30° C.

Thereafter, in order to simulate a battery producing process having a rest period after injecting the electrolyte solution, Nyquist plots were repeatedly measured for 24 hours immediately after producing the cell, and a Nyquist plot which showed a lowest impedance among the results measured within 24 hours was illustrated (FIGS. 20A and 20B), and the ionic conductivity was calculated to be represented in Table 4.

TABLE 4

| Electrolyte | Celgard (mS/cm) | GFF (mS/cm) |
|---|---|---|
| B7E3 | 0.09 | 3.02 |
| Dual B7E3 | 0.28 | 3.71 |

As a result, an impedance value of the dual B7E3 which used two salts was low (3.7Ω), as compared with the single salt B7E3 (12Ω), and when the impedance value was converted to the ionic conductivity, the dual B7E3 had three times or higher value than B7E3 with respect to the celgard separator. In addition, in the cell using the GFF separator, when two salts were used, an increase of ionic conductivity was observed.

By doing this, it was understood that when two types of salts were used for the BMEC based electrolyte, the movement of the ions in the electrolyte was smoother than that in the single salt, which was advantageous for rapid operation of the battery.

As described above, although example embodiment has been described by limited drawings, those skilled in the art may apply various technical modifications and changes based on the above description. For example, even when the above-described techniques are performed by different order from the described method and/or components described above are coupled or combined in a different manner from the described method or replaced or substituted with other components or equivalents, the appropriate results can be achieved.

Therefore, other implements, other embodiments, and equivalents to the claims are within the scope of the following claims.

What is claimed is:

1. An electrolyte, comprising: a linear organic carbonate compound represented by Chemical Formula 1, an electrolyte additive, and a lithium salt, 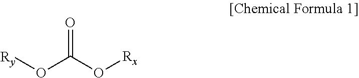
in Chemical Formula 1, Rₓ and R_{y} each includes at least one selected from the group consisting of an alkoxyalkyl group represented by the following Chemical Formula 2, an alkyl sulfanyl group represented by the following Chemical Formula 3, an alkyl amino group represented by the following Chemical Formula 4, and an alkyl group, 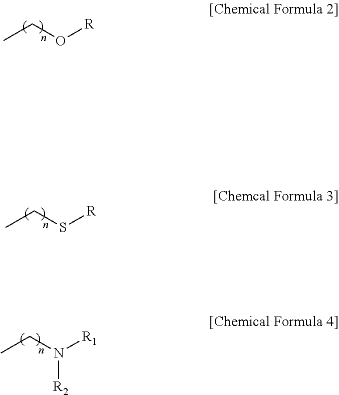
in Chemical Formulae 1 to 4, R, R₁, R₂, and the alkyl group are alkyl group having 1 to 4 carbon atoms and are substituted with one or more fluorines (F), and n is an integer of 1 to 4.

2. The electrolyte according to claim 1, wherein a flash point is 70° C. or higher, and in a separator condition which is formed of polypropylene (PP) or a combination of polypropylene and polyethylene (PE), an ionic conductivity at a room temperature is 0.05 mS/cm or higher.

3. The electrolyte according to claim 2, wherein at least one of Rₓ and R_{y} of Chemical Formula 1 includes one or more substituents selected from the group consisting of Chemical Formulae 2 to 4.

4. The electrolyte according to claim 2, wherein the linear organic carbonate compound includes one or more selected from the group consisting of bis(2-methoxyethyl) carbonate (BMEC), (2-methoxyethyl) methyl carbonate (MEMC), and (2-methoxyethyl) ethyl carbonate (MEEC).

5. The electrolyte according to claim 2, wherein the electrolyte additive includes one or more selected from the group consisting of fluoroethylene carbonate (FEC), vinylene carbonate (VC), vinyl ethylene sulfite, and vinyl ethylene carbonate.

6. The electrolyte according to claim 2, wherein a content of the added electrolyte additive is 10 vol % or lower based on the entire electrolyte.

7. The electrolyte according to claim 2, wherein the electrolyte additive is fluoroethylene carbonate (FEC) and an added content is 1 vol % or more and less than 4 vol %.

8. The electrolyte according to claim 2, wherein the lithium salt includes one or more selected from the group consisting of lithium hexafluorophosphate (LiPF₆), lithium bis(trifluoromethanesulfonyl)imide (LiTFSI), lithium bis(fluorosulfonyl)imide (LiFSI), lithium difluorophosphate, lithiumdifluoro(bisoxalato)phosphate, and lithium bis(oxalate)borate, and the lithium salt is included with a concentration of 0.5 to 2 M.

9. The electrolyte according to claim 8, wherein the lithium salt is LiPF₆ and LiTFSI.

10. The electrolyte according to claim 2, further comprising:
a solvent including a cyclic carbonate.

11. The electrolyte according to claim 10, wherein the cyclic carbonate includes one or more of ethylene carbonate (EC) and propylene carbonate (PC).

12. The electrolyte according to claim 10, wherein a content volume ratio of the linear organic carbonate to the cyclic carbonate included in the electrolyte is greater than 6:4 and less than or equal to 10:0.

13. A lithium secondary battery, comprising:
a positive electrode including a positive electrode active material;
a negative electrode including a negative electrode active material;
a separator located between the positive electrode and the negative electrode; and
the electrolyte according to claim 1.

14. An electric device, comprising the lithium secondary battery according to claim 13, wherein the electric device is a communication device, a transportation device, an energy storage device, or a sound device.
